(19) United States
(12) Patent Application Publication
(10) Pub. No.: US 2021/0217259 A1
(43) Pub. Date: Jul. 15, 2021

(54) System and Method For Communicating With A Vehicle

(71) Applicant: Huf North America Automotive Parts Manufacturing Corp., Milwaukee, WI (US)

(72) Inventors: Antonio Odejerte, Jr., Farmington Hills, MI (US); John Nantz, Brighton, MI (US)

(21) Appl. No.: 16/093,227

(22) PCT Filed: Apr. 14, 2017
(86) PCT No.: PCT/US2017/027610

§ 371 Date: Oct. 12, 2018

Related U.S. Application Data
(60) Provisional application No. 62/323,106, filed on Apr. 15, 2016.

(51) Int. Cl. G07C 9/00; H04W 84/18; H04W 4/40; H04W 4/80

(52) U.S. Cl. CPC G07C 9/00174; H04W 84/18; G07C 2009/00769; H04W 4/80; H04W 4/40

(57) ABSTRACT

An apparatus includes a first wireless communication node, a second wireless communication node, and a sensor. The first wireless communication node is operable to transmit a low-frequency wireless signal. The second wireless communication node is in communication with the first wireless communication node and is operable to transmit a short-range wireless signal. The second wireless communication node is operable in an ON mode and an OFF mode. The sensor is in communication with the second wireless communication node and is operable to sense a movement of the apparatus. The second wireless communication node is operable to switch from the OFF mode to the ON mode in response to the movement sensed by the sensor.

### CROSS REFERENCE TO RELATED APPLICATION

This application is the national phase of International Patent Application No. PCT/US2017/027610, filed Apr. 14, 2017, which claims priority to U.S. Provisional Application No. 62/323,106, filed Apr. 15, 2016, the disclosures of which are hereby incorporated by reference in their entirety.

### FIELD

The present disclosure relates generally to a system and method for communicating with a vehicle, and more particularly to a system and method for communicating with a vehicle using more than one wireless communication protocol.

### BACKGROUND

This section provides background information related to the present disclosure and is not necessarily prior art.

A wireless communication device, such as a key fob, a smartphone, a smart watch, or a computer (e.g., a tablet, laptop, personal digital assistant, etc.), for example, can be used to communicate with a motor vehicle. For example, a wireless communication device can communicate with a vehicle in order to access, diagnose faults, start/stop, and/or provide power to certain components and/or systems within the vehicle. In particular, a user may utilize a wireless communication protocol (e.g., short-range radio wave communication, Wi-Fi, BLUETOOTH®, near field communication (NFC), etc.) to access and/or operate the vehicle. In this regard, the operator may access and/or operate the vehicle by utilizing a wireless communication protocol controlled and powered by a smartphone.

While known systems and methods for communicating between a wireless communication device and a vehicle have proven acceptable for their intended use, such systems often require an excessive amount of power (e.g., from a battery) and may be susceptible to undesirable operating characteristics.

### SUMMARY

This section provides a general summary of the disclosure, and is not a comprehensive disclosure of its full scope or all of its features.

According to one aspect, the present disclosure provides an apparatus including a first wireless communication node, a second wireless communication node, and a sensor. The first wireless communication node may be operable to transmit a low-frequency wireless signal. The second wireless communication node may be in communication with the first wireless communication node and may be operable to transmit a short-range wireless signal. The sensor may be in communication with the second wireless communication node and may be operable to sense movement of the apparatus. The second wireless communication node may be operable to switch from an OFF mode to an ON mode in response to the movement sensed by the sensor.

In some implementations, the apparatus is one of a key fob, a smartphone, and a smartwatch.

In some implementations, the short-range wireless signal includes a Bluetooth Low Energy wireless signal.

The first wireless communication node may include a low-frequency node and the second wireless communication node may include a Bluetooth Low Energy node.

In some implementations, the apparatus includes an energy storage device operable to supply power to the first wireless communication node and the second wireless communication node.

The apparatus may include a first antenna and a first antenna controller. The first antenna controller may be in communication with the first antenna and the second wireless communication node. The apparatus may further include a second antenna in communication with the second wireless communication node.

In some implementations, the apparatus includes at least one user input device in communication with the second wireless communication node.

According to another aspect, the present disclosure provides a method for determining a location of a vehicle access device. The method may include sensing movement of a vehicle access device. The method may also include switching a first wireless communication node from a dormant state to an idle state based on the movement of the vehicle access device. The method may further include detecting a user input with the vehicle access device and transmitting a first signal with the first wireless communication node to a second wireless communication node.

In some implementations, the first wireless communication node includes a first Bluetooth Low Energy communication node. The second wireless communication node may include a second Bluetooth Low Energy communication node. The first Bluetooth Low Energy communication node may be disposed in the vehicle access device and the second Bluetooth Low Energy communication node may be disposed in a vehicle.

The method may include switching the first wireless communication node from the idle state to the dormant state after a predetermined amount of time. The method may also include switching the first wireless communication node from the idle state to the dormant state if the sensor does not detect another movement of the vehicle access device during the predetermined amount of time.

In some implementations, the method includes transmitting a second signal from the second wireless communication node to the first wireless communication node.

In some implementations, the method includes scanning for signals with the second wireless communication node.

The method may include transmitting a second signal from a third wireless communication node to a fourth wireless communication node. The second signal may include a low frequency wireless signal. The third wireless communication node may include a low frequency wireless communication node.

In some implementations, transmitting the first signal with the first wireless communication node to the second wireless communication node may include transmitting the first signal a plurality of times.

According to yet another aspect, the present disclosure provides a method of operating a vehicle communication system. The method may include determining a location of a vehicle access device, activating a low frequency wireless communication node based on the location, and transmitting a signal from the low frequency wireless communication node to a vehicle. The method may also include operating the vehicle based on the signal. The method may further include deactivating the low frequency wireless communication node, determining another location of the vehicle access device, and transmitting information to a vehicle operator based on the another location.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a functional block diagram of an example vehicle communication system according to the present disclosure;

FIG. 2 is another functional block diagram of the example vehicle communication system of FIG. 1;

FIG. 3 is a flowchart depicting an example method of controlling a vehicle communication system according to the present disclosure; and

FIGS. 4A-4B illustrate another example method of controlling a vehicle communication system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The description provided herein is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

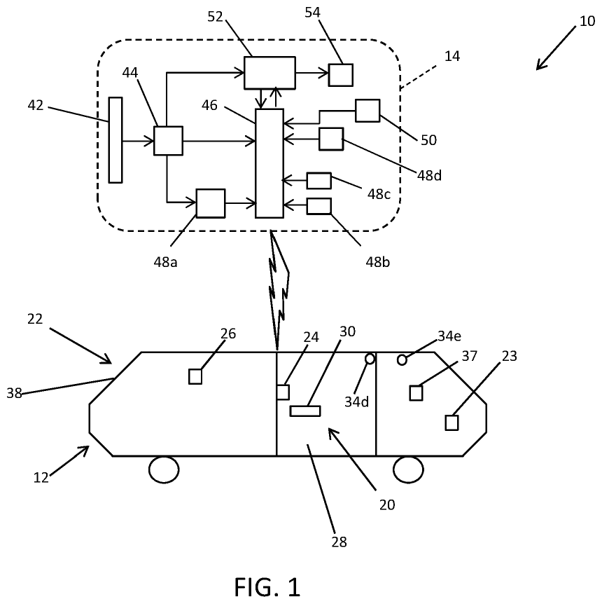

With reference to FIG. 1, a vehicle communication system 10 is provided. The vehicle communication system 10 may include a vehicle 12 and a vehicle access device 14. The vehicle 12 may be any known variety of motorized vehicle, such as a car, truck, or van, for example. In this regard, the vehicle 12 may be a private or commercial-type motor vehicle. In some configurations, the vehicle 12 may be one of a group of vehicles 12 that make up part of a fleet of vehicles, such as a fleet of rental vehicles or a fleet of commercial vehicles, such as delivery vehicles or service vehicles.

The vehicle 12 may include an access system 20, a communication system 22, and one or more control modules 23 (e.g., a body control module, an engine control module, a transmission control module, etc.). The access system 20 may include one or more locks 24, a lock control module 26, and one or more doors 28 and/or other access location(s). The locks 24 may permit and/or prevent access to the vehicle 12 through the doors 28. For example, each door 28 of the vehicle 12 may include a lock 24 and a handle 30. The lock control module 26 may communicate with the lock(s) 24 to permit and/or prevent operation of the handle 30 in order to permit and/or prevent access to the vehicle 12 through the doors 28. In this regard, the lock control module 26 may receive a signal from the vehicle access device 14 and control a state (e.g., locked or unlocked) of the lock(s) 24 based on the signal(s) received from the vehicle access device 14.

The communication system 22 may include one or more communication nodes 34, 34a-n and an infotainment system 37. For example, in some configurations, the communication system 22 includes five communication nodes 34, 34a-n. In particular, the communication system 22 may include a first communication node 34a, a second communication node 34b, a third communication node 34c, a wireless fourth communication node 34d, and a fifth communication node 34d.

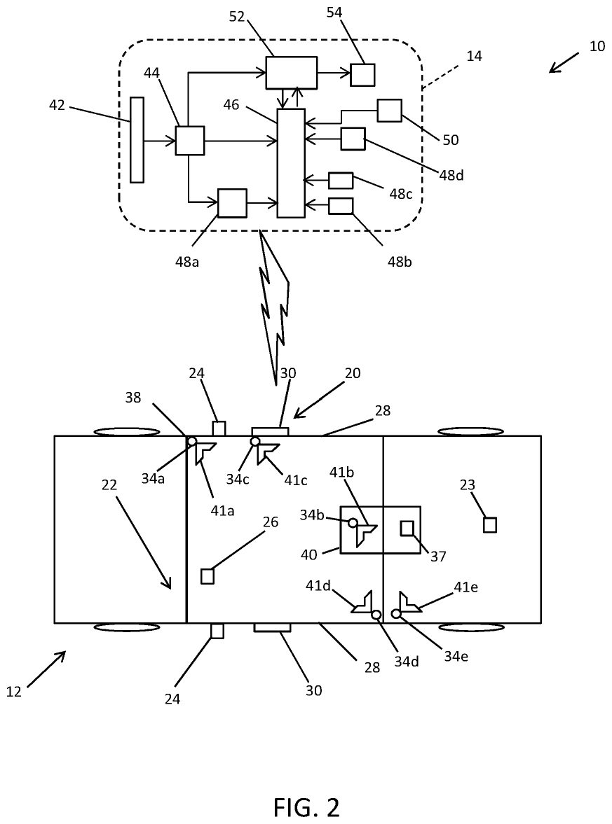

As illustrated in FIGS. 1 and 2, the communication nodes 34, 34a-n may be located in various locations on and/or in the vehicle 12. For example, the first communication node 34a may be located on a body portion of the vehicle 12. In particular, in some configurations, the first communication node 34a may be located on a C-pillar 38 of the vehicle 12. The second communication node 34b may be located proximate the center of the vehicle 12. For example, the second communication node 34b may be located proximate a center console 40 of the vehicle 12. The third communication node 34c may be located on one of the doors 28 of the vehicle 12. For example, in some configurations, the third communication node 34c may be located proximate to the door handle 30 on a driver's side of the vehicle 12. The fourth communication node 34d may be located proximate another one of the doors 28 of the vehicle 12. For example, in some configurations, the fourth communication node 34d may be located proximate the door handle 28 on a passenger side of the vehicle 12.

As will be explained in more detail below, each communication node 34, 34a-n may be configured to communicate with the other wireless communication node(s) 34 and/or the vehicle access device 14. For example, the communication nodes 34, 34a-n may communicate with one another, and with the vehicle access device 14, through one or more wired and/or wireless communication protocols, such as LIN Communication, CAN-FD communication, K-Line communication, short-range radio wave communication, Wi-Fi, BLUETOOTH®, and/or BLUETOOTH® low energy (BLE) (e.g., Mesh BLE or scatternet BLE). In some implementations, the first, second, third, and fourth communication nodes 34a, 34b, 34c, 34d may be BLE nodes, and the fifth communication node 34e may be a low-frequency (LF) node. In this regard, the first, second, third, and fourth communication nodes 34a, 34b, 34c, 34d may be referred to herein as BLE communication nodes 34a, 34b, 34c, and/or 34d, and the fifth communication node 34e may be referred to herein as an LF communication node.

Each communication node 34, 34a-n may include an address (e.g., a BLE address or an LF address) and an antenna 41, 41a-n. In some configurations, the first BLE communication node 34a may be assigned as a main or primary communication node 34a having a major BLE address. The primary communication node 34a may be responsible for long-range communication between the vehicle access device 14 and the vehicle 12. In particular, the primary communication node 34a may be responsible for communicating with the vehicle access device 14 when the distance between the vehicle access device 14 and the vehicle 12 is greater than approximately two meters. In some implementations, the primary communication node 34a may be responsible for communicating with the vehicle access device 14 when the distance between the vehicle access device 14 and the vehicle 12 is greater than approximately five meters.

The second, third, and fourth BLE communication nodes 34b, 34c, 34d may be assigned as secondary BLE communication nodes 34b, 34c, 34d, each having a minor BLE address. The minor BLE address of the secondary BLE communication node 34b may be different than the minor BLE address of each of the third and fourth BLE communication nodes 34c, 34d. Accordingly, the minor BLE addresses can allow the secondary BLE communication nodes 34b, 34c, 34d to be differentiated from each other and from the primary BLE communication node 34a, which can help the vehicle access device 14 to determine which of the BLE communication nodes 34a, 34b, 34c, 34d to communicate with when there is more than one vehicle 12. In particular, the vehicle access device 14 may include a table that groups the BLE communication nodes 34a, 34b, 34c on a specific vehicle 12, such that using the BLE addresses, including the minor BLE addresses, can help the vehicle access device 14 to determine which of the BLE communication nodes 34a, 34b, 34c, 34d the vehicle access device 14 should communicate with when there is more than one vehicle 12.

In some implementations, the system 10 may implement a localization strategy using one or more of the BLE communication nodes 34a, 34b, 34c, 34d. For example, the BLE communication nodes 34a, 34b, 34c, 34d may determine a location of the vehicle access device 14 based on a received single strength indication (RSSI) value (e.g., a calibration value) corresponding to a signal received from the vehicle access device 14. In other implementations, the BLE communication nodes 34a, 34b, 34c may determine a location of the vehicle access device 14 based on at least one of (i) the RSSI value, (ii) the angle at which a signal is received by, or transmitted from, the BLE communication nodes 34a, 34b, 34c, and (iii) the time at which a signal is received by, or transmitted from, the BLE communication nodes 34a, 34b, 34c.

The infotainment system 37 may allow the vehicle 12 to communicate with a user. For example, the infotainment system 37 may include a display (not shown) and/or a speaker (not shown) that allow the infotainment system 37 to send visual and/or audible instructions to the user. In this regard, the infotainment system may be in communication with one or more of the communication nodes 34, 34a-n, the vehicle access device 14, and/or the control module 23.

The control module 23 may control various aspects of accessing and/or operating the vehicle 12. For example, in some implementations, the control module 23 may be, or otherwise include, a body control module configured to communicate with the access system 20 and/or the communication system 22 in order to permit or prevent access to the vehicle 12 through the doors 28. In some implementations, the control module 23 may be, or otherwise include, an engine control module configured to permit or prevent access to the vehicle 12 via the engine (not shown). For example, the control module 23 may permit or prevent the vehicle access device 14 from starting and/or otherwise operating the engine of the vehicle 12. The communication nodes 34, 34a-n may communicate with the control module 23 through one or more wired and/or wireless communication protocols, such as LIN Communication, CAN-FD communication, and/or K-Line communication.

The vehicle access device 14 may include a wireless communication device such as a key fob, a smartphone, a smart watch, or a computer (e.g., a tablet, laptop, personal digital assistant, etc.), for example. The vehicle access device 14 may include a power source 42, a capacitor 44, a first wireless communication node 46, a first input source or device 48a, a second input source or device 48b, a third input source or device 48c, a first antenna 50, a second wireless communication node 52, and a second antenna 54. The power source 42 may include a battery or other suitable source of electrical power. In some implementations, the power source 42 may include a coin cell battery. The capacitor 44 may be in wired or wireless communication with the power source 42. In this regard, the capacitor 44 may be wired to the power source 42 in order to selectively receive an electrical charge from the power source 42.

The first wireless communication node 46 may communicate with the capacitor 44, the first, second, and third input devices 48a, 48b, 48c, the first antenna 50, and the second wireless communication node 52. The first wireless communication node 46 may communicate through one or more wireless communication protocols, such as short-range radio wave communication, Wi-Fi, BLUETOOTH®, and/or BLE. In this regard, the first wireless communication node 46 may be referred to herein as the BLE communication node 46.

In some implementations, the first wireless communication node 46 may receive (i) power from the capacitor 44, and (i) communication (e.g., inputs) from one or more of the first, second, and third input devices 48a, 48b, 48c, the first antenna 50, and the second wireless communication node 52. In this regard, as will be explained in more detail below, the first wireless communication node 46 may receive a motion-related input from the first input device 48a, a clock signal-related input from the second and/or third input devices 48b, 48c, a user-related input from the third input device 48d, a vehicle-related input from the first antenna 50, and a vehicle-related input from the second wireless communication node 52.

The first, second, and third input devices 48a, 48b, 48c may receive input from various sources. For example, the first, second, and third input devices 48a, 48b, 48c may receive an input from one or both of the vehicle 12 and a user. As will be explained in more detail below, the first, second, and third input devices 48a, 48b, 48c may transmit, or otherwise utilize, the input to control access to and/or operation of the vehicle 12

The first input device 48a may be a motion-related sensor such as a micro-electromechanical sensor, for example. In this regard, the first input device 48a may be configured to determine motion-related characteristics of the vehicle access device 14, such as velocity, acceleration, and/or deceleration. The first input device 49a may transmit the motion-related characteristics, and/or an input corresponding to the motion-related characteristics, to the first wireless communication node 46.

The second and third input devices 48b, 48c may each include a clock generator. For example, the second input device 48b may include a low frequency clock generator, and the third input device 48c may include a high frequency clock generator. In this regard, the second input device 48b may produce an input such as a low frequency clock signal (e.g., 32.768 kHz), and the third input device 48c may produce an input such as a high frequency clock signal (e.g., 1.0 MHz). The second and third input devices 48b, 48c may transmit the low and high frequency clock signals, respectively, to the first wireless communication node 46.

The fourth input device 48d may include a user input device. For example, the fourth input device 48d may include a touch-screen, a microphone, one or more push-buttons, or another suitable device configured to allow the user to input a command to the vehicle access device 14. In some implementations, the fourth input device 48d includes one or more push-buttons (e.g., an unlock button, a lock button, a start button, a stop button, etc.) that allow the user to input corresponding commands to the first wireless communication node 46.

The first antenna 50 may include a ceramic chip, printed circuit board, or other suitable antenna, internal to the vehicle access device 14, for transmitting a signal to, and/or receiving a signal from, the vehicle 12 and the vehicle access device 14. In some implementations, the first antenna 50 may include a BLE antenna configured to transmit a BLE signal to one or more of the BLE communication nodes 34a, 34b, 34c, 34d of the vehicle 12 from the first wireless communication node 46 of the vehicle access device 14, and to receive a BLE signal from one or more of the BLE communication nodes 34a, 34b, 34c, 34d of the vehicle 12 at the first wireless communication node 46 of the vehicle access device 14. In this regard, the BLE communication nodes 34, 34a-n of the vehicle 12 and the first wireless communication node 46 of the vehicle access device 14 may transmit and receive signals through the antennas 41, 41a-n and the first antenna 50, respectively.

The second wireless communication node 52 may communicate with the capacitor 44, the second antenna 54, and the second wireless communication node 52. The second wireless communication node 52 may communicate through one or more wireless communication protocols, such as short-range radio wave communication, Wi-Fi, BLUETOOTH®, and/or BLE. In this regard, the second wireless communication node 52 may transmit and receive low-frequency, short-range radio waves. Accordingly, the second wireless communication node 52 may be referred to herein as the LF communication node 52.

In some implementations, the second wireless communication node 52 may receive (i) power from the capacitor 44, and (i) communication (e.g., inputs) from one or more of the second antenna 54, and the first wireless communication node 46. In this regard, as will be explained in more detail below, the second wireless communication node 52 may (i) receive a signal (e.g., wake-up signal) from the first wireless communication node 46 and (ii) transmit and receive vehicle-related signals from the second antenna 54.

The second antenna 54 may include an antenna for transmitting a signal to, and/or receiving a signal from, the vehicle 12 and the vehicle access device 14. The second antenna 54 may include a 3D low-frequency antenna configured to transmit a low-frequency signal to the LF communication node 34e of the vehicle 12 from the second wireless communication node 52 of the vehicle access device 14, and to receive an LF signal at the second wireless communication node 52 of the vehicle access device 14 from the LF communication node 34e. In this regard, the LF communication node 34e of the vehicle 12 and the second wireless communication node 52 of the vehicle access device 14 may transmit and receive signals through the antenna 41e and the second antenna 54, respectively.

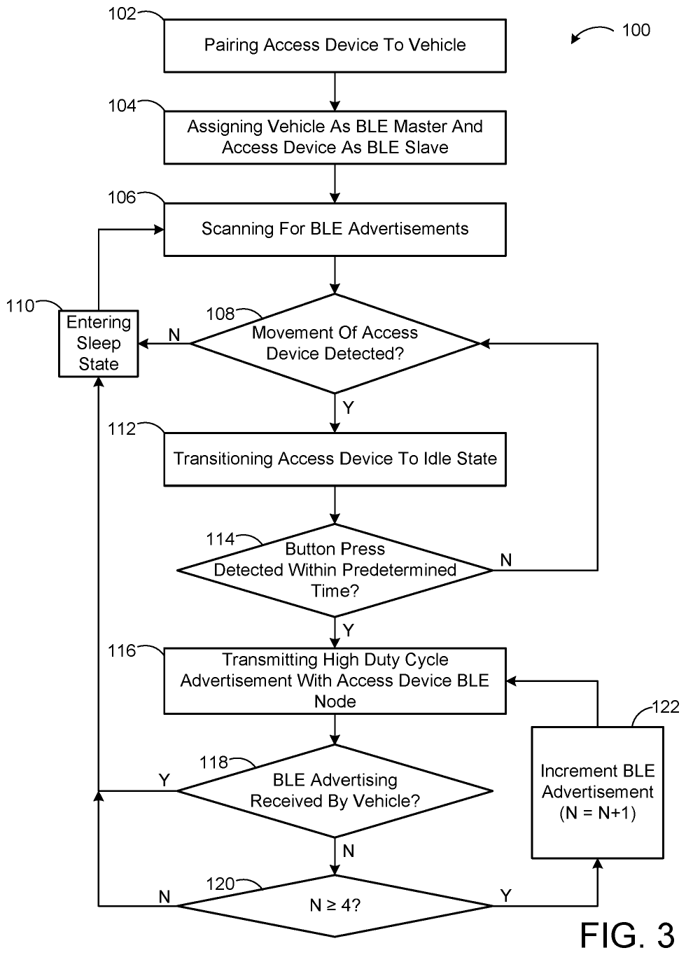

With reference to FIG. 3, a method for accessing and/or controlling the vehicle 12 with the vehicle access device 14, and/or determining whether to permit the vehicle access device 14 to access the vehicle 12, is illustrated at 100. In this regard, the method 100 may correspond to a method for remotely accessing the vehicle 12 with the vehicle access device 14.

At 102, the method 100 may include pairing, or otherwise establishing a secure connection between, the vehicle access device 14 and the vehicle 12. For example, the vehicle access device 14 and the vehicle 12 may exchange security credentials, such as identification codes, for example. In some implementations, at 102, the vehicle access device 14 may transmit security credentials (e.g., an identification code corresponding to the vehicle access device 14) to the vehicle 12, and the vehicle 12 may transmit security credentials (e.g., an identification code corresponding to the vehicle 12) to the vehicle access device 14. In this regard, the wireless communication node 46 of the vehicle access device 14 and the communication node 34a of the vehicle 12 may share and store a link key (e.g., a pass code) in order to establish a secure connection between the nodes 52, 34a. The primary communication node 34a may also share the link key with the secondary communication nodes 34b, 34c, 34d such that the secondary communication nodes 34b, 34c, 34d are securely connected to the wireless communication node 52 of the vehicle access device 14.

At 104, the method 100 may include assigning one of the vehicle 12 and the vehicle access device 14 as a BLE central device (e.g., master) and the other of the vehicle 12 and the vehicle access device 14 as a BLE peripheral device (e.g., slave). For example, the method 100 may include assigning the vehicle 12 as the BLE master and the vehicle access device 14 as the BLE slave. In this regard, at 104, the vehicle 12 may be assigned to scan or listen for BLE signals (e.g., advertisements, including packets of information), and the vehicle access device 14 may be assigned to transmit BLE signals. In some implementations, one or more of the communication nodes 34, 34a-d may be assigned to scan for advertisements transmitted from one or more other wireless communication nodes (e.g., first wireless communication node 46).

At 106, the method 100 may include scanning for BLE advertisements with the BLE central device. For example, at 106, the BLE master (e.g., one or more of the communication nodes 34, 34a-d) may scan for BLE advertisements. In some implementations, the first communication node 34a may scan for BLE advertisements.

At 108, the method 100 may include monitoring for, and/or otherwise detecting, a first input to the vehicle access device 14. For example, at 108, the method may include detecting a movement of the vehicle access device 14. In this regard, the method 100 may include determining whether the vehicle access device 14 has been moved. For example, the first input device 48a (e.g., micro-electromechanical sensor) may sense a motion-related characteristic (e.g., velocity and/or acceleration) of the vehicle access device 14. If 108 is false, the BLE peripheral device may remain in, or otherwise be transitioned to, a dormant or sleep state at 110 and the method 100 may return to 106 where the first communication node 34a may continue scanning for BLE advertisements. As used herein, the dormant or sleep state will be understood to be a state in which the BLE peripheral device (e.g., the vehicle access device 14, including one or both of the first and second wireless communication nodes 46, 52) is consuming a small amount of power (e.g., less than one micro-ampere) from the power source 42, as compared to an amount of power consumed by the vehicle access device 14 in an idle or wake state. If 108 is true, the method may proceed to 112.

At 112, the method 100 may include transitioning the BLE peripheral device (e.g., the vehicle access device 14) from the dormant or sleep state to the idle or wake state. For example, at 112, the method may include transitioning one or both of the first and second wireless communication nodes 46, 52 from the dormant or sleep state to the idle or wake state.

At 114, the method 100 may include monitoring for, and/or otherwise detecting, a second input to the vehicle access device 14. For example, at 114, the method may include determining whether an input to the fourth input device 48d occurs within a predetermined amount of time. The predetermined amount of time may be an amount of time (e.g., approximately 0.1 seconds to approximately 15 seconds) following the detection of the first input at 108. In some implementations, the method may include detecting whether a button of the fourth input device 48d has been pressed or otherwise engaged within the predetermined amount of time. For example, the clock generators of the second and/or third input devices 48b, 48c may determine whether the second input to the vehicle access device 14 is received within the predetermined amount of time. If 114 is false, the method may return to 108, wherein the first input device 48a may monitor for the first input to the vehicle access device 14. If 114 is true, the method may proceed to 116.

At 116, the method 100 may include transmitting a high duty cycle advertisement (e.g., 3.5 milliseconds to 5.0 milliseconds) from one of the vehicle access device 14 and the vehicle 12 to the other of the vehicle access device 14 and the vehicle 12. For example, at 116, the method may include transmitting a high duty cycle advertisement from the first wireless communication node 46 of the vehicle access device 14.

At 118, the method 100 may include determining whether the high duty cycle advertisement transmitted at 116 has been received by one of the communication nodes 34, 34a-n of the vehicle 12. In this regard, at 118, the method may include determining whether one of the antennas 41, 41a-d of vehicle 12 has received the high duty cycle advertisement from the antenna 50 of the vehicle access device 14. If 118 is true, the method may include processing the command corresponding to the second input and to the high duty cycle advertisement, and proceeding to 110. In this regard, if 118 is true, the method 100 may process the command corresponding to the second input by instructing (e.g., via the control module 23) the lock module 26 to transmit a lock signal to the locks 24. For example, if 118 is true, the method may include transmitting a signal from the lock control module 26 to the locks 24 in order to change the locks 24 from a locked state to an unlocked state, or from the unlocked state to the locked state. Once the command corresponding to the second input has been processed, the method 100 may return to 110 where the vehicle access device 14 may be transitioned to the dormant or sleep state. If 118 is false, the method may proceed to 120.

At 120, the method may determine whether a number of transmissions of the high duty cycle advertisement transmitted at 116 exceeds a predetermined threshold. For example, at 120, the method may determine whether a counter N, corresponding to the number of transmissions of the high duty cycle advertisement at 116, is greater than or equal to four. If 120 is true, the method may return to 110 where the vehicle access device 14 may be transitioned to the dormant or sleep state. If 120 is false, the method may proceed to 122. At 122, the method may increment the counter N corresponding to the number of transmissions of the high duty cycle advertisement at 116, and then return to 116.

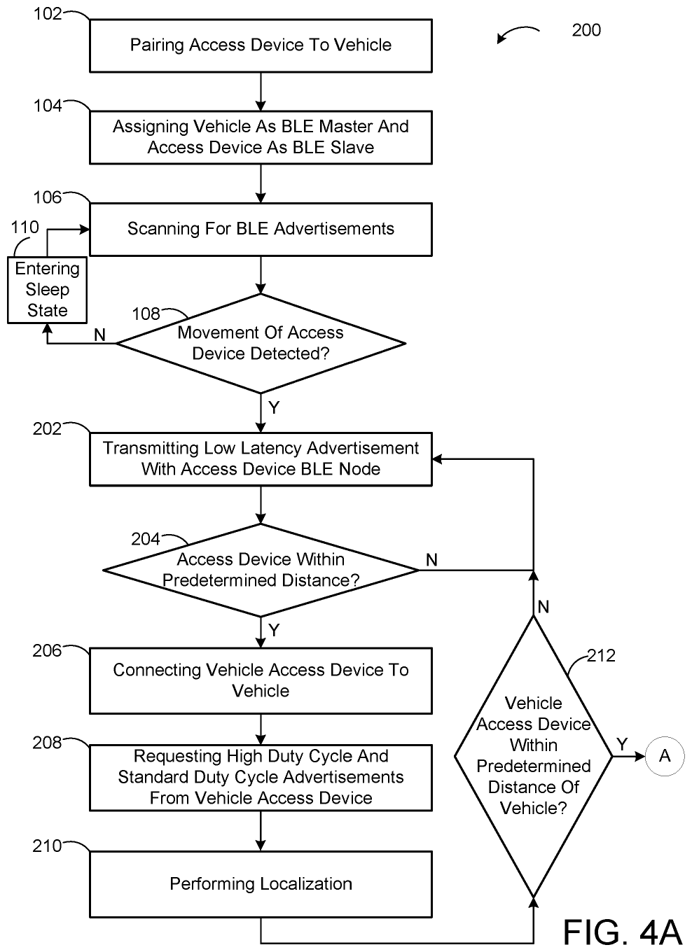

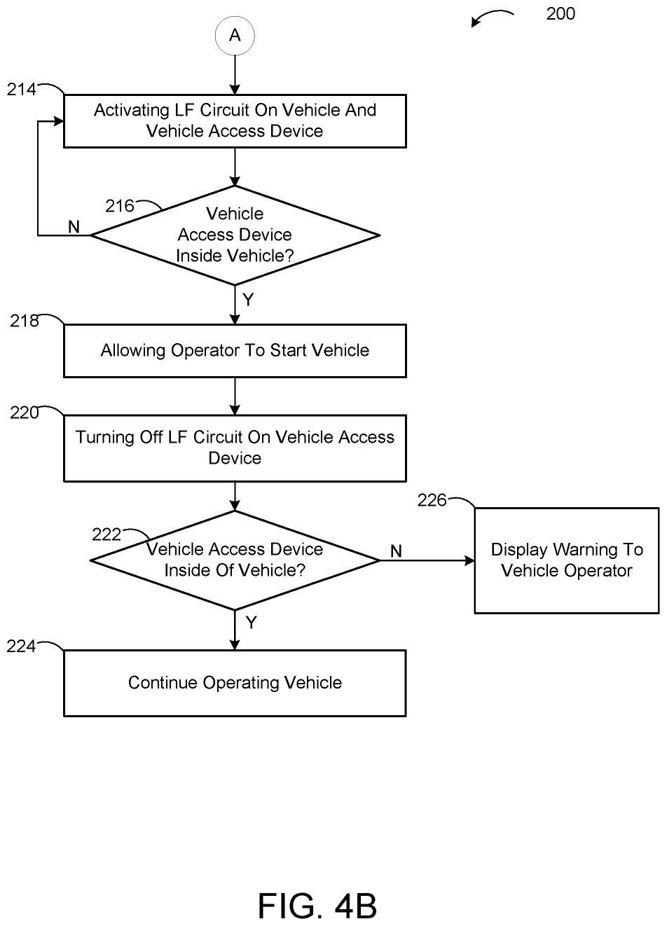

With reference to FIGS. 4A-4B, another method of operating the system 10, is illustrated at 200. The method 200 may correspond to a method for remotely and passively accessing and/or controlling (e.g., starting) the vehicle 12 with the vehicle access device 14. The method 200 may be substantially similar to the method 100, except as otherwise provided herein. For example, the method 200 may begin after completing steps 102, 104, 106, 108, and/or 110 of the method 100.

At 202, the method 200 may include transmitting a low latency advertisement from one of the vehicle access device 14 and the vehicle 12 to the other of the vehicle access device 14 and the vehicle 12. For example, at 202, the method may include transmitting a low latency advertisement from the first wireless communication node 46 of the vehicle access device 14. The transmission at 202 may be at a power level that is low enough to conserve power from the power source 42, but high enough to ensure receipt by one of the communication nodes 34, 34a-d of the vehicle 12.

At 204, the method 200 may include determining whether the vehicle access device 14 is within a predetermined distance of the vehicle 12. For example, at 204, the method may include utilizing one or more of a variety of localization methods in order to determine whether the vehicle access device 14 is within a detection range (e.g., less than approximately ten meters) of one of the communication nodes 34, 34a-n on the vehicle 12. In some implementations, the method may utilize RSSI values, angle-of-arrival, angle-of-departure, and/or time-of-flight information, corresponding to the advertisements transmitted at 202, in order to determine whether the first wireless communication node 46 of the vehicle access device 14 is within approximately ten meters of the second communication node 34b on the vehicle 12. If 204 is false, the method may return to 202. If 204 is true, the method may proceed to 206.

At 206, the method may include wirelessly connecting the vehicle access device 14 to the vehicle 12. For example, at 206, the method may include establishing a wireless connection between the first wireless communication node 46 and one of the communication nodes 34, 34a-n, and/or between the second wireless communication node 52 and the communication node 34e.

At 208, the method may include transmitting high duty cycle and standard duty cycle advertisements from one of the vehicle access device 14 and the vehicle 12 to the other of the vehicle access device 14 and the vehicle 12 in order to determine the location of the vehicle access device 14 relative to the vehicle 12. For example, at 208, at least one of the communication nodes 34, 34a-n (e.g., communication node 34a) may request that the first wireless transmission node 46 transmit alternating high duty cycle and standard duty cycle advertisements. The high and standard duty cycle advertisements can be used by the system 10, including the vehicle 12, in a localization method (e.g., RSSI, angle-of-arrival, angle-of-departure, and/or time-of-flight) in order to determine the location of the vehicle access device 14 at 210.

At 212, the method 200 may include determining whether the vehicle access device 14 is within a predetermined distance of the vehicle 12. For example, at 212, the method may determine whether the location determined at 210 is less than or equal to a predetermined distance (e.g., approximately one meter). If 212 is false, the method may return to 202 where the first wireless communication node 46 may transmit low latency advertisements. If 212 is true, the method may proceed to 214.

At 214, the method 200 may include activating (i) the fifth, or LF, communication node 34e of the vehicle 12 and/or (ii) the second, or LF, wireless communication node 52 of the vehicle access device 12. For example, at 214, the system 10 may instruct the LF communication node 34e of the vehicle and the LF communication node 52 of the vehicle access device 14 to transmission from an OFF or sleep state to an ON or wake state.

At 216, the method 200 may include determining whether the vehicle access device 14 is inside the vehicle 12. For example, at 216, the method 200 may include performing a localization method (e.g., RSSI, angle-of-arrival, angle-of-departure, and/or time-of-flight) based on a signal transmitted from one of the LF communication nodes 34e, 52. If 216 is false, the method 200 may return to 214. If 216 is true, the method 200 may proceed to 218 where the method may include allowing the user to operate the vehicle 12. For example, at 218, the method 200 may include allowing the user to start the engine of the vehicle 12.

At 220, the method 200 may include changing the state of at least one of the LF communication nodes 34e, 52. For example, at 200, the method may include changing the state of the LF communication node 52 of the vehicle access device 14 from the ON state to the OFF state in order to reduce the amount of power transmitted from the power source 42 to the LF communication node 52.

At 222, the method 200 may include determining whether the vehicle access device 14 is inside the vehicle 12. For example, at 222, the method 200 may include utilizing RSSI values, angle-of-arrival, angle-of-departure, and/or time-of-flight information, corresponding to the advertisements transmitted from the first wireless communication node 46 of the vehicle access device, in order to determine whether the first wireless communication node 46 is inside of the vehicle 12. If 222 is true, the method 200 may proceed to 224 where the method may include allowing the user to continue operating the vehicle 12, including the engine. If 222 is false, the method 200 may proceed to 226 where the method 200 may include transmitting a corresponding warning signal to the user. For example, at 226, the system 10 may transmit an audio or visual message to the user in order to inform the user that the vehicle access device 14 is not inside the vehicle 12, even though the engine of the vehicle 12 may be operating. In some implementations, the system 10 may display a visual message to the user on the infotainment system 37.

The system 10 and method 200 may help to prevent the user from driving the vehicle 12 without the vehicle access device 14 and, thereafter, upon turning off the engine, not being able to operate the vehicle 12.

The following Clauses provide an exemplary configuration for an article of footwear described above.

Clause 1: A method comprising sensing a movement of a vehicle access device, switching a first wireless communication node from a dormant state to an idle state based on the movement of the vehicle access device, detecting a user input with the vehicle access device and transmitting a first signal with the first wireless communication node to a second wireless communication node.

Clause 2: The method of Clause 1, wherein the first wireless communication node includes a first Bluetooth Low Energy communication node.

Clause 3: The method of Clause 2, wherein the second wireless communication node includes a second Bluetooth Low Energy communication node.

Clause 4: The method of Clause 3, wherein the first Bluetooth Low Energy communication node is disposed in the vehicle access device and the second Bluetooth Low Energy communication node is disposed in a vehicle.

Clause 5: The method of Clause 1, further comprising switching the first wireless communication node from the idle state to the dormant state after a predetermined amount of time.

Clause 6: The method of Clause 5, wherein a sensor does not detect another movement of the vehicle access device during the predetermined amount of time.

Clause 7: The method of Clause 1, further comprising transmitting a second signal from the second wireless communication node to the first wireless communication node.

Clause 8: The method of Clause 7, further comprising scanning for signals with the second wireless communication node.

Clause 9: The method of Clause 1, further comprising transmitting a second signal from a third wireless communication node to a fourth wireless communication node.

Clause 10: The method of Clause 9, wherein the second signal includes a low frequency wireless signal.

Clause 11: The method of Clause 9, wherein the third wireless communication node includes a low frequency wireless communication node.

Clause 12: The method of Clause 1, wherein transmitting the first signal with the first wireless communication node to the second wireless communication node includes transmitting the first signal a plurality of times.

Clause 13: An apparatus comprising a first wireless communication node operable to transmit a low-frequency wireless signal, a second wireless communication node in communication with the first wireless communication node and operable to transmit a short-range wireless signal, the second wireless communication node operable in an ON mode and an OFF mode, and a sensor in communication with the second wireless communication node and operable to sense a movement of the apparatus, the second wireless communication node operable to switch from the OFF mode to the ON mode in response to the movement sensed by the sensor.

Clause 14: The apparatus of Clause 13, wherein the apparatus is one of a key fob, a smartphone, and a smartwatch.

Clause 15: The apparatus of Clause 13, wherein the short-range wireless signal includes a Bluetooth Low Energy wireless signal.

Clause 16: The apparatus of Clause 13, wherein the first wireless communication node includes a low-frequency node and the second wireless communication node includes a Bluetooth Low Energy node.

Clause 17: The apparatus of Clause 13, further comprising an energy storage device operable to supply power to the first wireless communication node and the second wireless communication node.

Clause 18: The apparatus of Clause 13, further comprising a first antenna, and a first antenna controller in communication with the first antenna and the second wireless communication node.

Clause 19: The apparatus of Clause 18, further comprising a second antenna in communication with the second wireless communication node.

Clause 20: The apparatus of Clause 13, further comprising at least one user input device in communication with the second wireless communication node.

Clause 21: A method comprising determining a first location of a vehicle access device, activating a low frequency wireless communication node based on the first location, transmitting a signal from the low frequency wireless communication node to a vehicle, operating the vehicle based on the signal, deactivating the low frequency wireless communication node, determining a second location of the vehicle access device, and transmitting information to a vehicle operator based on the second location.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method comprising:
sensing a movement of a vehicle access device;
switching a first wireless communication node from a dormant state to an idle state based on the movement of the vehicle access device;
detecting a user input with the vehicle access device; and
transmitting a first signal with the first wireless communication node to a second wireless communication node.

2. The method of claim 1, wherein the first wireless communication node includes a first Bluetooth Low Energy communication node.

3. The method of claim 2, wherein the second wireless communication node includes a second Bluetooth Low Energy communication node.

4. The method of claim 3, wherein the first Bluetooth Low Energy communication node is disposed in the vehicle access device and the second Bluetooth Low Energy communication node is disposed in a vehicle.

5. The method of claim 1, further comprising switching the first wireless communication node from the idle state to the dormant state after a predetermined amount of time.

6. The method of claim 5, wherein a sensor does not detect another movement of the vehicle access device during the predetermined amount of time.

7. The method of claim 1, further comprising transmitting a second signal from the second wireless communication node to the first wireless communication node.

8. The method of claim 7, further comprising scanning for signals with the second wireless communication node.

9. The method of claim 1, further comprising transmitting a second signal from a third wireless communication node to a fourth wireless communication node.

10. The method of claim 9, wherein the second signal includes a low frequency wireless signal.

11. The method of claim 9, wherein the third wireless communication node includes a low frequency wireless communication node.

12. The method of claim 1, wherein transmitting the first signal with the first wireless communication node to the second wireless communication node includes transmitting the first signal a plurality of times.

13. An apparatus comprising:
a first wireless communication node operable to transmit a low-frequency wireless signal;
a second wireless communication node in communication with the first wireless communication node and operable to transmit a short-range wireless signal, the second wireless communication node operable in an ON mode and an OFF mode; and
a sensor in communication with the second wireless communication node and operable to sense a movement of the apparatus, the second wireless communication node operable to switch from the OFF mode to the ON mode in response to the movement sensed by the sensor.

14. The apparatus of claim 13, wherein the apparatus is one of a key fob, a smartphone, and a smartwatch.

15. The apparatus of claim 13, wherein the short-range wireless signal includes a Bluetooth Low Energy wireless signal.

16. The apparatus of claim 13, wherein the first wireless communication node includes a low-frequency node and the second wireless communication node includes a Bluetooth Low Energy node.

17. The apparatus of claim 13, further comprising an energy storage device operable to supply power to the first wireless communication node and the second wireless communication node.

18. The apparatus of claim 13, further comprising:
a first antenna; and
a first antenna controller in communication with the first antenna and the second wireless communication node.

19. The apparatus of claim 18, further comprising a second antenna in communication with the second wireless communication node.

20. The apparatus of claim 13, further comprising at least one user input device in communication with the second wireless communication node.

21. A method comprising:
determining a first location of a vehicle access device;
activating a low frequency wireless communication node based on the first location;
transmitting a signal from the low frequency wireless communication node to a vehicle;
operating the vehicle based on the signal;
deactivating the low frequency wireless communication node;
determining a second location of the vehicle access device; and
transmitting information to a vehicle operator based on the second location.
